(19) United States
(12) Patent Application Publication
(10) Pub. No.: US 2018/0112628 A1
(43) Pub. Date: Apr. 26, 2018

(54) Rocket Engine Ignition System

(71) Applicant: ECAPS Aktiebolag, Solna (SE)

(72) Inventor: Kjell Anflo, Haninge (SE)

(21) Appl. No.: 15/572,440

(22) PCT Filed: May 9, 2016
(86) PCT No.: PCT/SE2016/050415

§ 371 Date: Nov. 7, 2017

(30) Foreign Application Priority Data
May 8, 2015 (EP) 15166991.8
Jun. 18, 2015 (EP) 15445001.9

(51) Int. Cl. F02K 9/95

(52) U.S. Cl. CPC F02K 9/95; F05D 2260/99

(57) ABSTRACT

The present invention relates to an ignition system for a liquid propellant chemical rocket engine, which comprises a thermal-catalytic element (20) for initiating decomposition of the liquid propellant, and an electrical heater (30) for electrically preheating the thermal-catalytic element, wherein the thermal-catalytic element is thermally connected to the electrical heater, both of which are located in a flow path of the propellant, a rocket engine, and a preburner, respectively, comprising the ignition system, as well as a method of preheating a liquid propellant rocket engine using the system, and a spacecraft comprising such engine.

### FIELD OF THE INVENTION

The present invention relates to an ignition system for a liquid propellant chemical rocket engine, which comprises a thermal-catalytic element for initiating decomposition of the liquid propellant, and an electrical heater for electrically preheating the thermal-catalytic element, wherein the thermal-catalytic element is thermally connected to the electrical heater, both of which are located in a flow path of the propellant, a rocket engine, and a preburner, respectively, comprising the ignition system, as well as a method of preheating a liquid propellant rocket engine using the system, and a spacecraft comprising such engine.

### BACKGROUND ART

In missiles, space launch vehicles, orbit raisers and in-space applications, such as satellites and other spacecraft, liquid propellant thrusters, liquid propellant rocket engines, and liquid propellant gas generators are often used. Such thrusters and rocket engines can for example be used for the purpose of manoeuvring and attitude control of missiles and satellites, and for roll control and propellant settling of the main propulsion system of other space vehicles, in which case the thrusters, or rocket engines are often used in continues firing, off-modulation firing, pulse mode and single pulse firing, where the firing duration typically can be fractions of a second to hours. For such purposes thrusters, or rocket engines, can be used with a thrust of typically from 0.1 N to about 5 kN.

Such thrusters may advantageously be operated on reduced risk liquid storable propellants, such as Ammonium DiNitramide (ADN) based liquid monopropellants, and bipropellants, e.g. High Performance Green Propulsion (HPGP) monopropellants, and bipropellants, or on hydroxyl ammonium nitrate (HAN) based liquid monopropellants, and bipropellants. Thrusters and the functional elements thereof such as the injector and reactor for such propellants have been described in e.g. WO 02/095207, WO 2013/169192, WO 2013/169193, and WO 2014/189451.

However, reduced risk liquid storable propellants based on ionic liquids based on ADN, HAN etc., are to date not known to spontaneously decompose (i.e. at room temperature) over a catalyst fast enough to meet the operational requirements for monopropellant thrusters, nor are known to be hypergolic with a second propellant in dual mode or bipropellant thrusters. Therefore the major drawback of thrusters for the above reduced risk liquid storable propellants is that they are not known to be able to be cold started to achieve nominal ignition, but require preheating of the thermo/catalytic reactor to a temperature of about 300-400° C. in order to achieve nominal ignition. Such prior art thermo/catalytic reactors include a heat bed. In the prior art, preheating of the heat bed, which bed may exhibit catalytic activity, is accomplished by means of an electrical heater located outside the engine with a thermal connection in between. For example, according to WO 2013/050507 thrusters are typically heated by means of heating applied to the external surface of the hollow body of the thruster, or applied to the injector.

In the above prior art thrusters the reduced risk liquid storable propellant is distributed in liquid phase by an injector into a preheated reactor. The first stage of the preheated reactor, i.e. the heat bed of the above prior art reactors, (which acts like a heat reservoir) brings the propellant into gas phase by means of boiling. After ignition, the first stage of the reactor acts as a thermal choke, thus suppressing the back flow of heat from overheating the injector and feed tube. The principle for propellant decomposition, ignition, and sustained combustion is described in WO 02/095207, WO 2013/169192, WO 2013/169193, and WO 2014/189451.

For such reduced risk liquid storable propellant thrusters having a thrust level of approximately 0.1 to 2 N the required electrical power consumption and start-up time (i.e. the reactor preheating duration in the case of the above reduced risk liquid storable propellant thrusters) is slightly higher but still comparable to the start-up time of similar hydrazine thrusters, e.g. less than 10 W and a preheating time of 15 to 30 minutes before the thruster can be fired giving nominal performance.

However, the present inventor has found that, for the above reduced risk liquid storable propellant thrusters, with increasingly higher thrust levels the electrical power and preheating time, i.e. the energy required, increases significantly as compared to a hydrazine thruster of comparable thrust level, which in addition can also be cold started (i.e. without any preheating) in emergency. The number of cold starts performed with a thruster comprising a catalyst will however severely limit its operational life time.

Making the reduced risk liquid storable propellant more reactive with an aim to enable cold start in order to solve the issue of increasingly higher required energy consumption and start-up time would severely deprive the reduced risk propellant of its advantageous properties, such as e.g. being associated with a reduced risk, and being stable and storable, as the resulting propellant thereby would become significantly more sensitive.

Accordingly, it would be desirable to be able to reduce the start-up time of a thruster for a liquid ADN based monopropellant, without having to alter the composition of the monopropellant to make it more sensitive or reactive, thus resulting e.g. in a different and more limiting transport classification of the propellant.

### SUMMARY OF THE INVENTION

The present inventor has found that the total start-up time and electrical energy required to achieve propellant decomposition and ignition leading to sustained combustion in thrusters designed in accordance to the prior art described in WO 02/095207, WO 2013/169192, WO 2013/169193, and WO 2014/189451 can be significantly reduced by the invention which is based on a relatively simple and low cost device, and which will have minimum impact on the vehicle's system design or mission constraints.

Accordingly, for a prior art ignition system for a liquid propellant chemical rocket engine, comprising injector 10 for injection of a liquid propellant, a catalytic element 20 for initiating decomposition of the liquid propellant, and an electrical heater 30 for electrically preheating the catalytic element, the above problem has been solved by means of using a catalytic element thermally connected to an electrical heater located in a flow path of the propellant. The inventive combination of the catalytic element and electrical heater is also referred to as igniter 100. The catalytic element thermally connected to the electrical heater, i.e. igniter 100, can either be located in the flow path of the propellant into the reactor of a rocket engine 1, in the flow path of the propellant into the reactor of a preburner 200 connected to a rocket engine 2, or inside a preburner 300 connected to injector 405 of the engine 3.

By placing the electrical heater inside the reactor radiation losses during pre-heating will be significantly reduced as compared to a prior art exterior heater relying on heat transfer from outside the reactor to the heat bed inside the reactor. Accordingly, by means of the present invention, using a given electric power, heating up to a given pre-heating temperature can be accomplished substantially faster. Moreover, by means of the present invention, using a given electrical power, a significantly higher pre-heating temperature is obtainable.

In a first aspect the invention relates to the above inventive ignition system for a liquid propellant chemical rocket engine 1, 2, 3 comprising: an injector 10 for injection of a liquid propellant; a catalytic element 20 for initiating decomposition of the liquid propellant; and an resistive electrical heater (30) for electrically preheating the catalytic element, wherein the catalytic element is thermally connected to said resistive electrical heater, so as to form a combination 100 of said heater and said catalytic element, wherein said combination is referred to as an igniter 100, and wherein said catalytic element and heater are located in a flow path of the propellant.

The inventive ignition system can be used in and implemented into the reactor of a liquid propellant chemical rocket engine 1 of the prior art.

Accordingly, in a further aspect the present invention relates to a liquid propellant chemical rocket engine 1 including a reactor comprising the inventive ignition system, wherein the flow path is that of the propellant into the reactor of the rocket engine 1. Such implementation of the inventive ignition system is primarily intended for small thrusters (i.e. with a nominal thrust below approximately 50 N), such as e.g. having a nominal thrust within the range of 0.1 N to 50 N.

Since the thermal choking properties of the upstream part of the reactor according to the invention can be made more efficient, the upstream part can be shortened (thus reducing combustion chamber volume), as compared to a prior art reactor, and thereby the inventive thruster can achieve a faster thrust response.

The inventive ignition system can also form part of a preburner 200 attached to an engine 2 of the prior art.

Accordingly, in embodiment the inventive system relates to an ignition system for a liquid propellant chemical rocket engine 2 which system is comprised in a preburner 200, further comprising a preburner combustion chamber 110; and an outlet 220 from the combustion chamber for hot gases to be led into the rocket engine 2. Such implementation of the inventive ignition system is primarily intended for larger thrusters (i.e. with a thrust above approximately 50 N), such as e.g. having a nominal thrust within the range of 50 N to 2 kN, wherein the ignition system is placed in a preburner 200, which in turn heats the reactor of the thruster 2.

In a further aspect the invention relates to a liquid propellant chemical rocket engine 2 comprising the inventive preburner ignition system, wherein the ignition system is located upstream of the rocket engine, and the outlet 220 of the preburner 200 is connected to the upstream end of the rocket engine 2, so that hot gases from the preburner can be led into the rocket engine.

In yet a further aspect the invention relates to a liquid propellant chemical rocket engine 3, comprising the inventive ignition system, wherein the ignition system is integrated into a preburner 300 connected to the injector 405 of the rocket engine, so that a hot gas flow 440 from the preburner can be directed towards a portion of the inner surface of the rocket engine reactor housing which surface is located upstream of the catalyst bed, and wherein the injector 405 is configured to spray the propellant 430 towards said portion of the inner surface of the reactor housing. Such implementation of the inventive ignition system is primarily intended for even larger thrusters, i.e. with a thrust of approximately 200 N, or more, such as e.g. having a thrust within the range of 200 N to 2 kN.

In yet an aspect the invention relates to a spacecraft comprising an engine 1, and/or 2, and/or 3 of the invention.

In a preferred embodiment of the inventive ignition system the heater voltage is the same as the voltage for the thruster propellant flow control valve(s), in order not to complicate the control system electronics.

In a preferred embodiment the injector 10 and igniter 100 are integrated and fabricated by means of Additive Manufacturing, in order to achieve optimum efficiency, reliability and lowest non-recurring cost.

In yet a further aspect the invention relates to a method of preheating a liquid propellant rocket engine 1, 2, 3 comprising the steps of: A) heating by means of a resistive electrical heater 30 a catalytic element 20 to a pre-determined temperature; B) providing a flow of a liquid monopropellant; C) contacting the flow of liquid propellant with the heated catalytic element, so as to evaporate and initiate decomposition of the liquid propellant; D) combusting the liquid propellant, so as to form hot gases; and, E) leading the hot gases downstream through the engine 1, 2, 3 so as to heat same, wherein, in step A, the electrical heat is generated inside the reactor of the engine 1, inside the reactor of a preburner 200 attached to the engine 2, or inside a preburner 300 connected to injector 405 of the engine 3, by means of a resistive electrical heater 30.

In one embodiment the method of preheating is carried out so as to accomplish an ignition sequence of one or more heating (start-up) pulses, which precede the start of the engine, in which case steps A through E are carried out intermittently so as to accomplish pulsed heating of the engine.

The inventive ignition system is intended for use with a high performance, low-hazard and environmental benign propellant, such as e.g. HAN or ADN based propellants, for example LMP-103S, or similar, which do not spontaneously decompose fast enough over a not preheated catalyst, nor are hypergolic with another high performance, low-hazard and environmental benign propellant. A major advantage of the invention is that the ignition system can be operated on same propellant as the rocket engine 1, 2, 3 itself. It is further conceived that the inventive ignition system also could be used with nitrous oxide monopropellant.

The inventive ignition system is primarily intended for engines with a thrust within the range of 0.1 N to about 5 kN, but could possibly also be used with larger engines, especially in bipropellant applications.

The inventive ignition system can e.g. be used in the dual mode engines disclosed in WO 2014/189451 when hydrogen peroxide is not being used for preheating the dual mode bipropellant engine disclosed therein.

The inventive ignition system can be used for reducing the required pre-heating time of a liquid propellant chemical rocket engine, and/or for reducing the electrical energy required for preheating a liquid propellant chemical rocket engine.

Further advantages and embodiments will be apparent from the following detailed description and appended claims.

### Definitions

The inventive combination of catalytic element 20 and electrical heater 30 will also be referred to herein as “primary reaction stage”, “first catalytic stage”, or “igniter” 100. Accordingly, as used herein the term “igniter” 100 denotes a combination of a catalytic element 20 and an electrical heater 30, wherein the catalytic element is thermally connected to the electrical heater, and is preferably also attached to said heater.

As used herein the term “combustion chamber” 50, 110, 210, 450 includes the overall interior volume of the thruster 1, 2, 3, and preburner 200, respectively, i.e. the volume downstream of the injector 10, 15, and 405, respectively, and notably the catalyst bed. Accordingly, at instances, 50, 110, 210, and 450, respectively, has been used to denote the catalyst bed of the corresponding combustion chamber.

### BRIEF DESCRIPTION OF THE ATTACHED DRAWINGS

FIG. 1 shows a cross-sectional view of a 20 N engine 1 of the invention having the inventive ignition system integrated into the reactor of the engine.

FIG. 2 shows a preferred embodiment of the inventive igniter 100.

FIG. 3 shows a cross-sectional view of a first embodiment of a 200 N engine 2 of the invention, having the ignition system implemented into a preburner 200 attached to the reactor of engine 2.

FIG. 4 shows a cross-sectional view of a second embodiment of a 200 N engine 3 of the invention, wherein the inventive igniter 100 is used as a preburner connected to the injector 405 of the reactor of engine 3. This embodiment combines the inventive igniter with the injection and heating of propellant disclosed in EP 15163530.7.

FIG. 5 shows the temperature in the catalytic bed 50 downstream of the electrical heater 30 during heating (beginning at 0 seconds in FIG. 5).

FIG. 6 shows the electrical power consumption during the heating shown in FIG. 5.

FIG. 7 shows the required start-up energy for prior art thrusters, as well as the projected energy required when using the inventive igniter 100.

### DETAILED DESCRIPTION

In the prior art the electrical heater of a rocket engine for ADN-based liquid propellants has invariably been located outside the engine. The present inventors have found that the heater can be placed within the reactor. According to the invention the propellant is by means of the injector 10 sprayed on to a heated catalytic element 20, which is thermally connected to an electrical heater 30, thus leading to decomposition, ignition and combustion of the propellant.

The catalytic element preferably exhibits a large catalytic surface for enhanced contact with the propellant and for enhanced catalytic capacity, and preferably exhibits low mass in order to be able to heat up more quickly by the electrical heater. Accordingly, in a preferred embodiment the inventive igniter 100 is designed to have low mass, thus being able to heat up quickly by the electrical heater.

The electrical heater 30 of igniter 100 is located in close proximity to the catalytic element 20, and is thermally connected to the catalytic element, and is also preferably attached to the electrical heater.

The igniter will be cooled by the flow of propellant being sprayed onto the igniter. At the same time, the igniter will absorb heat from the downstream combustion and function as a heat reservoir, and, thus, in this sense, function as a prior art heat bed.

The electrical heater is preferably a fast response electrical heater.

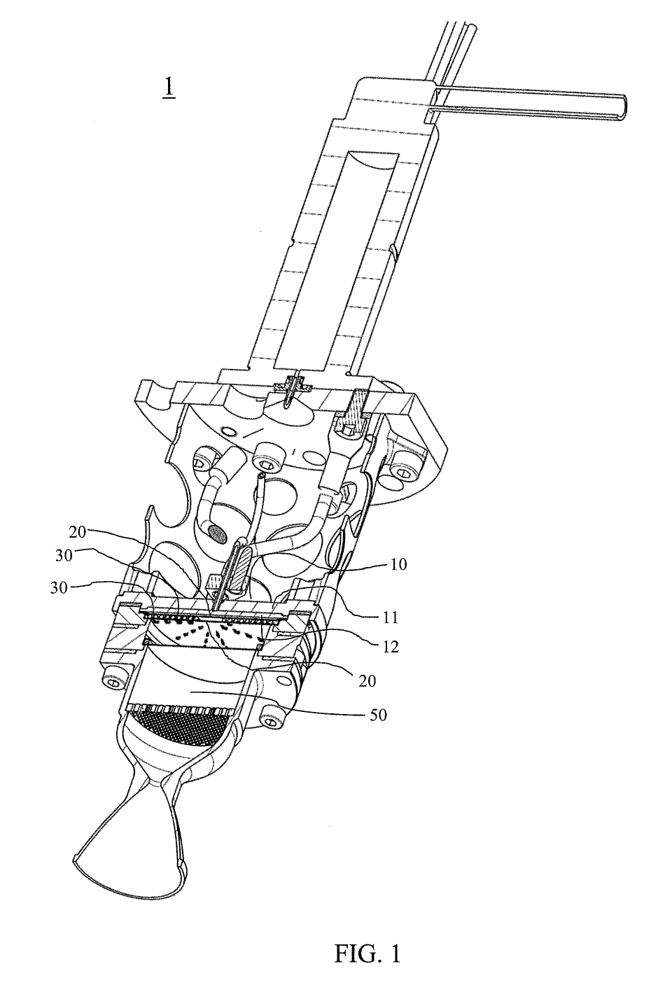

The function of the injector 10 of the invention is to distribute the propellant over the igniter, such as by spraying. In a preferred embodiment of the invention the injector also serves to finely divide into droplets or atomize the propellant being injected in order to further enhance the heat transfer from the catalytic element to the propellant and contact of the propellant with the catalytic element. Such embodiment is shown in FIG. 1. With reference to FIG. 1, the injector 10 comprises an injector head 11, and an injector face 12.

Upon contact with the hot surface of the catalytic element ignition of the propellant is initiated, which generates gas and heat, which will flow downstream in the combustion chamber and heat the reactor of the engine 1, 2.

In a preferred embodiment of the invention the injector 10, design and choice of material (e.g. materials with high thermal conductivity) thereof, are such that the injector is efficiently cooled by the propellant. For example, by means of a plurality of orifices (not shown) distributed over the surface of injector face 12, cooling of the injector face by means of liquid propellant being injected will be enhanced.

Accordingly, in a preferred embodiment of the invention, a shower head injector is used to spray the propellant on to the igniter, as shown in FIG. 1.

The inventive ignition system may preferably be operated such that the primary reaction stage is superheated, i.e. to a temperature which is significantly higher than for the prior art reactor ignition temperatures, i.e. well above 300° C., more preferably well above 400° C., such as a temperature within the range of e.g. 500-800° C., more preferably 700-800° C. As pointed out above, with the heater located inside the reactor of a rocket engine 1, or of a preburner 200, a substantially higher pre-heating temperature can be reached within a shorter time. Also, such superheating will incur significantly reduced electrical start-up energy consumption. The benefit with superheating is that the primary reaction stage can handle significantly higher propellant flow rates for a given size, since the propellant decomposition becomes much faster, thus providing much higher heat release within the primary reaction stage. At the superheating temperature a larger number of decomposition and combustion reactions will occur than at the lower prior art heating temperature of 300-400° C. Accordingly, at superheating temperature also some of the prior art reactions only occurring downstream will now occur already at the primary reaction stage, thus providing more heat upstream.

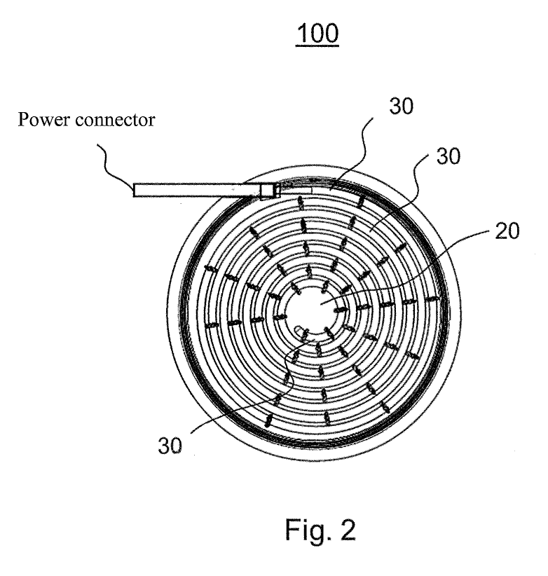

The catalytic element 20 should be thermally conductive and light weight, and can for example comprise a mesh, as in FIG. 2, a sponge or honeycomb structure. The catalytic element is preferably metallic. A suitable material for the catalytic element is a Pt/Rh alloy.

The heater 30 preferably comprises a heating element in the form of a cable. The cable is preferably provided in the form of a flat spiral coil, e.g. as shown in FIG. 2. The heating cable must have a heat resistant sheath, preferably a Pt/Rh sheath. The sheath should be catalytic, so as to endow the inventive heater with catalytic properties.

The heater 30 is attached to the catalytic element 20. For example, a heating cable may be attached to a catalytic mesh by means of stitches, such as shown in FIG. 2. More than one catalytic element 30 may be stacked to the heater. For example, a catalytic element 20 may be attached both to the upstream, and the downstream sides, respectively, of the heater 30.

According to the invention the heater 30 preferably supports the catalytic element(s) 20, and the catalytic element(s) preferably supports the heater. Inventive igniter 100 could also comprise two or more heaters stacked in a staged structure with catalytic elements in between the heaters.

The igniter must be permeable to the combustion gases, e.g. such as the igniter shown in FIG. 2, comprising a heater cable coil 30 attached by means of stitches to a platinum (Pt) mesh 20.

In a preferred embodiment of the inventive ignition system the injector 10 and igniter 100 are integrated and fabricated by means of Additive Manufacturing in order to achieve optimum efficiency, reliability and lowest non-recurring cost.

When implemented into an engine as described in WO 02/095207, WO 2013/169192, WO 2013/169193, and WO 2014/189451 the inventive igniter 100 is placed upstream of the catalyst bed.

By means of an injector face 12 capable of distributing the propellant over the whole cross-section of the reactor onto the igniter, the thermal choke properties of the inventive engine will be improved over the prior art engines, due to more effective cooling of the injector face.

By means of introducing into the inventive ignition system a small distance (not shown) separating injector face 12 and igniter 100, distribution of propellant over the igniter can be improved. At the same time, heat transfer from downstream combustion will be further suppressed, since direct heat transfer by conduction from the heat bed to the injector face thereby will be inhibited. Instead, back flow of heat from downstream combustion to the injector face will be limited to radiation of heat from the igniter and heat bed, and to heat conducted to the injector via the walls of the reactor.

Accordingly, since the thermal choke properties of the upstream part of the reactor according to the invention can be made more efficient, the upstream part of the reactor can be shortened, thus reducing the combustion chamber volume, and thereby the inventive thruster 1 can achieve faster thrust response.

When integrated into a rocket engine 1 the heat generated by the combustion of the propellant upon ignition using the inventive ignition system may be sufficient to achieve sustained combustion in the engine. In instances when sustained combustion cannot be obtained upon ignition, pulsed heating can be used according to the invention as will be described below.

When implemented into a prior art reactor, the igniter 100 will typically replace a portion of the heat bed of the reactor. However, the mass, and therefore also heat capacity, of the inventive igniter is reduced as compared to the corresponding omitted portion of the prior art heat bed. Accordingly, depending on the temperature, the mass of the igniter, and temperature of the downstream catalyst bed, the heat produced upon ignition of the propellant flow using the inventive igniter might not be sufficient for establishing sustained combustion in the engine 1. In such case, in order to avoid a wash-out and undesired cooling of the igniter and catalyst bed, pulse mode firing wherein one start-up (heating) pulse or a train of shorter start-up pulses is fired is used to sufficiently heat the catalyst bed to lead to sustained combustion in engine 1.

During a start-up pulse the catalyst bed will be heated by the partly decomposed hot gas from the igniter, which gas will begin to further decompose the propellant components into an increasingly exothermal reaction leading to increased catalyst bed temperature and increased combustion efficiency. A number of start-up pulses can be used to heat the primary reaction stage and catalyst bed to a sufficiently high temperature so that sustained combustion can be obtained upon ignition next.

In a preferred embodiment of the inventive igniter 100, the electrical heater is embedded in a catalytic mesh (or sponge) which has a good thermal conductivity, e.g. about 50 W/mK, a low relative mass, and which is significantly thermally decoupled from the thruster structure. The igniter is the held in place by a ceramic peripheral support with low thermal conductivity. The catalytic mesh extends from the heater both upstream towards the injector, and downstream of the heater towards the main reactor. The purpose of this design of the igniter is to completely atomize the propellant before it enters into the downstream main reactor. The invention thereby minimizes or even eliminates the upstream heat bed (which may exhibit catalytic activity) in prior art thruster designs.

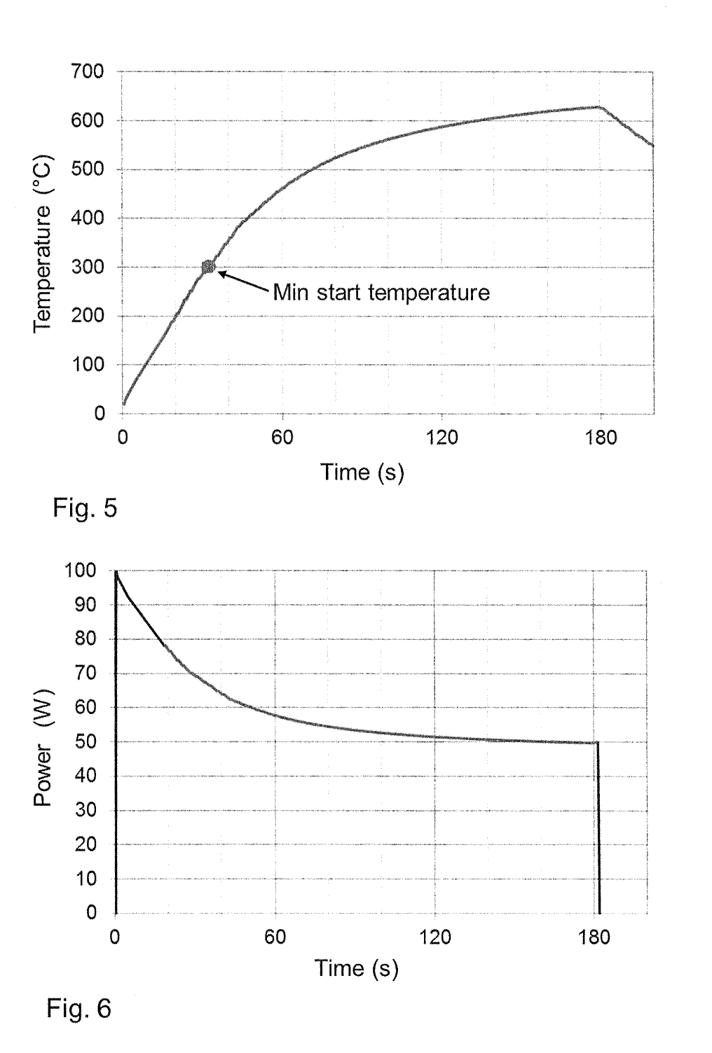

The inventors have verified the thermal response (shown in FIG. 5) of the invention by means of an igniter prototype with embedded heater built into a thruster such as shown in FIG. 1. At, and above, 300° C. (achieved in about 30 seconds), the reactor has reached a temperature where the propellant decomposition leading to ignition is fast enough to achieve the desired thrust build-up response time, shown as a dot in FIG. 5 (denoted “Min start temperature”). The target for the invention was to reach the ignition temperature in less than 60 seconds. The higher the reactor temperature is, the higher bed loads (i.e. propellant flow rates) the igniter can handle without being saturated. After 180 s the heater power is switched off, as shown by a temperature drop, and a power drop, in FIGS. 5 and 6, respectively. In FIG. 6 the supply voltage is 28 VDC and the power is “automatically” reduced due to the physical characteristics (resistance vs. temperature) of the heater which will reach thermal equilibrium and maintain the desirable start temperature during heating period. The energy required to heat the prototype to 300° C. within 30 seconds is 72 kJ. This corresponds to at least 20% less energy consumption compared to prior art.

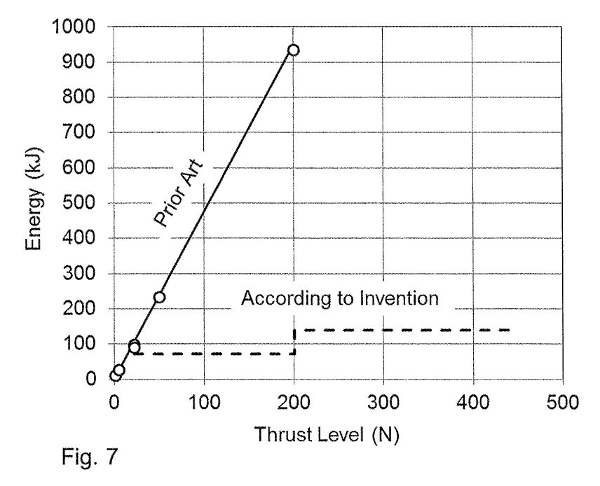

However, for larger thrusters of prior art the required energy to bring the reactor to nominal start temperature for firing will significantly increase with thruster size as can be seen from FIG. 7.

The prototype igniter with embedded heater has the capacity to ignite 10 to 25 N thrusters. For somewhat larger thrusters the inventive igniter can be up-scaled, but this may increase the required electrical power and/or heating time.

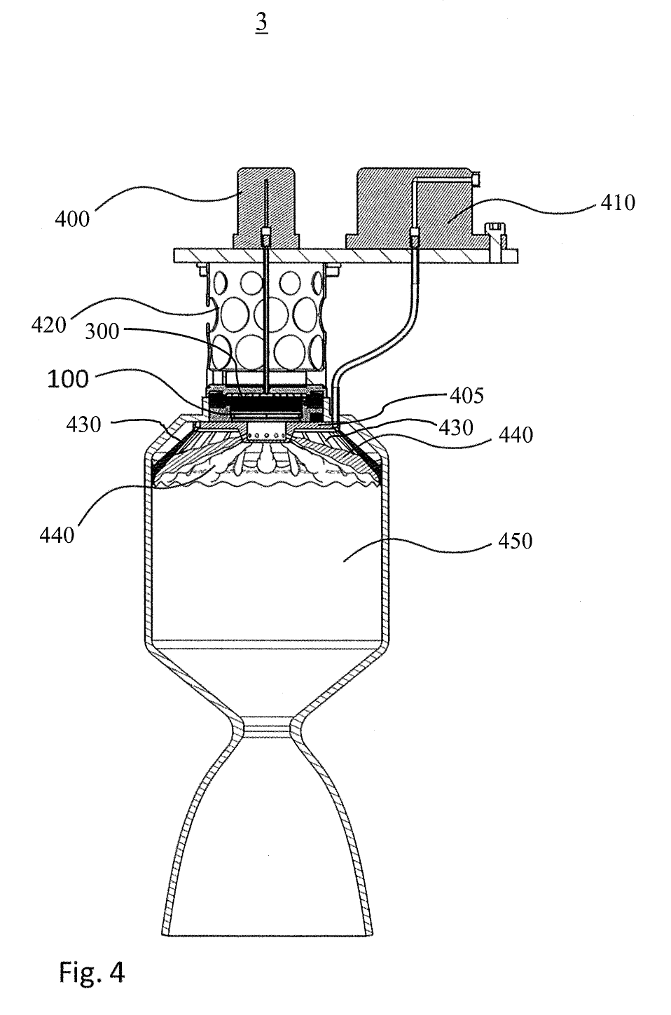

For yet larger thrusters, such as the 200 N thruster 3 shown in FIG. 4, the inventive igniter can be used as a preburner as shown in FIG. 4. In FIG. 4 reference numeral 400 denotes igniter propellant valve, 410 denotes a main propellant flow valve, 420 is a thermal stand-off, 440 igniter hot gas flow, 430 main propellant flow, and 450 represents the main catalyst bed. The embedded igniter can for example be used in a 200 N thruster. For such larger thrusters, the injector and design disclosed in EP 15163530.7 can be used, e.g. as shown in FIG. 4. The hot atomized propellant from the embedded igniter is directed against the wall of the reactor and combusted therein. When a sufficiently high preheating temperature has been accomplished in the main reactor by means of the inventive preburner, the main reactor is ready for start, and the main propellant flow valve can be opened. With reference to FIG. 7, the use of the inventive igniter as a preburner in a larger thruster, such as 200 N and larger, will significantly reduce the required start-up energy as compared to a prior art thruster, and also the heating time.

In a preferred embodiment of the inventive liquid propellant chemical rocket engine 1, a flow restrictor (not shown), preferably a cavitating venturi, is implemented into the propellant flow path in the thruster 1 upstream of the injector 10 in order to suppress the propellant flow surge, which otherwise will occur at the beginning of each pulse fired and before the combustion chamber pressure is built up, which leads to excessive cooling of the ignition system and upstream part of the reactor. A flow restrictor, such as a cavitating venturi, may similarly be implemented in the engine 3, upstream of injector 405, on either or both of the main propellant feed line, and igniter propellant feed line.

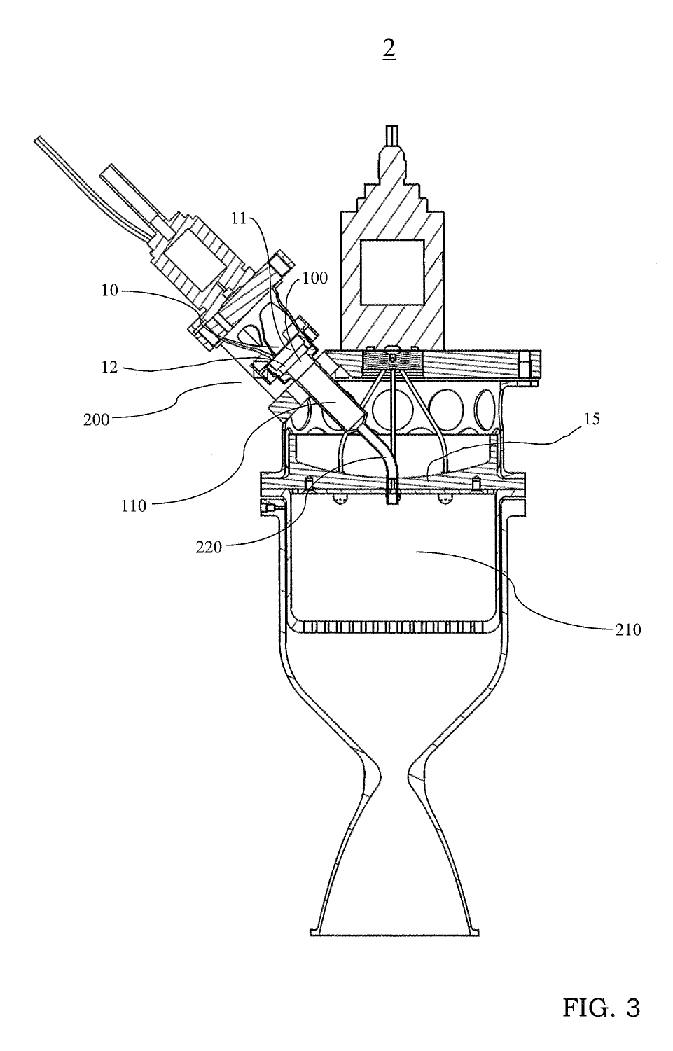

When implemented into a preburner 200 as shown in FIG. 3, according to the invention, pulse mode firing of the igniter 100 will be used, comprising one or more start-up pulses of the preburner, until the heat bed and catalyst bed of the thruster 2 are sufficiently heated for sustained combustion to be accomplished upon ignition of the thruster 2.

The principal design of the inventive preburner 200 is similar to that of an engine 1, except for the downstream nozzle of the engine and the presence of the inventive igniter. Accordingly, with reference to FIG. 3, the inventive preburner 200 comprises from the downstream end an outlet 220 for hot gases, a preburner combustion chamber 110 comprising a catalyst bed and heat bed, an igniter 100, and an injector 10, which injector comprises injector head 11 and injector face 12.

As will be obvious to the person of ordinary skill in the art, a conventional small liquid propellant chemical thruster could be used to preheat a larger thruster 2. Such solution is however not considered sufficiently effective by the present inventor, and thus inferior to the solution offered herein, which is based on the use of the inventive igniter.

A flow restrictor (not shown), preferably a cavitating venturi flow restrictor, may preferably be implemented into the propellant flow path to the preburner upstream of the injector 10 in order to suppress the propellant flow surge, which otherwise will occur at the beginning of each pulse fired and before the combustion chamber pressure is built up in the preburner. A flow restrictor (not shown) is preferably also implemented into the propellant flow path to the thruster 2 upstream of the injector 15 of rocket engine 2.

In a preferred embodiment of the inventive ignition system one or more temperature sensors, i.e. thermocouples, are implemented into the igniter 100, which are used for monitoring and control of the ignition sequence. In a preferred embodiment of the inventive ignition system the temperature sensor is the heater 30 itself, which is used as part of a thermocouple.

An initial firing sequence of the inventive thruster 1 or preburner 200 (of inventive engine 2) begins with electrically powering the heater 30, thus bringing the igniter 100 to its operational temperature within typically about ten seconds. Immediately thereafter, one start-up (heating) pulse, or a train of shorter start-up pulses is fired (typically a few seconds), to sufficiently heat the catalyst bed to lead to sustained combustion. Thereafter, typically within 60 seconds the thruster 1, 2 is ready for immediate firing of any pulses. If no pulses are fired the reactor temperature slowly decreases until the lower temperature limit where nominal firing can be performed is reached. Temperature sensor(s) indicates when this limit is reached and a heating pulse is fired again. Conservation of heat using the engine concept of WO 2013/169192 will delay the temperature decrease and the time until the lower temperature limit where nominal firing can be performed is reached.

1. An ignition system for a liquid propellant chemical rocket engine comprising:
an injector that injects a liquid propellant;
a catalytic element that initiates decomposition of the liquid propellant; and
a resistive electrical heater that electrically preheats the catalytic element,
wherein the catalytic element is thermally connected to said resistive electrical heater, so as to form a combination of said heater and said catalytic element, wherein said combination is referred to as an igniter, and wherein said catalytic element and heater are located in a flow path of the propellant.

2. A liquid propellant chemical rocket engine, comprising the ignition system of claim 1, wherein the ignition system is integrated into the reactor of the rocket engine, and wherein the flow path is that of the propellant into the reactor of the rocket engine.

3. The ignition system of claim 1 for a liquid propellant rocket engine, which system is comprised in a preburner, wherein the system additionally comprises:
a preburner combustion chamber; and
an outlet from the preburner combustion chamber for hot gases to be led into the rocket engine for heating the rocket engine, wherein the flow path is that of the propellant into the preburner.

4. A liquid propellant chemical rocket engine, comprising the ignition system of claim 3, wherein the ignition system is located upstream of the rocket engine and the outlet of the system is connected to the upstream end of the rocket engine, so that hot gases from the preburner can be led into the rocket engine.

5. A liquid propellant chemical rocket engine, comprising the ignition system of claim 1, wherein the ignition system is integrated into a preburner connected to the injector of the rocket engine for preheating the rocket engine, which preburner is configured so as to enable a hot gas flow from the preburner to be directed towards a portion of the inner surface of the rocket engine reactor housing which surface is located upstream of the catalyst bed of the rocket engine, and wherein the rocket engine injector is configured to spray the propellant towards said portion of the inner surface of the rocket engine reactor housing.

6. The chemical rocket engine of claim 2, wherein one or more temperature sensors are implemented into the igniter.

7. A method of preheating a liquid propellant chemical rocket engine comprising:
A heating by means of a resistive electrical heater a catalytic element to a pre-determined temperature by electrically generating heat inside a reactor of the engine, inside a preburner attached to the engine, or inside a preburner connected to an injector of the engine;
B providing a flow of a liquid monopropellant;
C contacting the flow of liquid propellant with the heated catalytic element, so as to evaporate and initiate decomposition of the liquid propellant;
D combusting the liquid propellant, so as to form hot gases; and,
E leading the hot gases downstream through the engine so as to heat the engine.

8. The method of claim 7, wherein the flow of liquid monopropellant is sprayed, atomized, or finely divided into droplets before being contacted with the catalytic element.

9. The method of claim 7, wherein operations A through E are carried out intermittently, so as to accomplish pulsed heating of the engine.

10. The method of claim 7, additionally comprising detecting the preheating temperature at one or more given locations in the reactor of the engine, or of the preburner.

11. The method of claim 7, wherein operations A through D are carried out in a preburner connected to the upstream end of the rocket engine, so that, in step E, hot gases from the preburner can be led into the rocket engine.

12. The method of claim 7, wherein operations A through E are repeated until sufficient preheating temperature of the engine has been achieved in order for sustained combustion in the engine to be attainable upon injection therein of the liquid propellant.

13. A spacecraft comprising a liquid propellant chemical rocket engine of claim 2.
